(19) United States
(12) Patent Application Publication
(10) Pub. No.: US 2017/0034182 A1
(43) Pub. Date: Feb. 2, 2017

(54) SYSTEM AND PROTOCOL FOR PROGRAMMATIC INHERITANCE OF DIGITAL ASSETS

(71) Applicant: OMNE TEMPUS LLC, Raritan, NJ (US)

(72) Inventors: Mauro Marson, Piscataway, NJ (US); Marco Benucci, Warren, NJ (US)

(21) Appl. No.: 15/296,000

(22) Filed: Oct. 17, 2016

Related U.S. Application Data
(63) Continuation of application No. 14/275,819, filed on May 12, 2014, now abandoned.

(51) Int. Cl. H04L 29/06

(52) U.S. Cl. CPC H04L 63/102; H04L 63/08

(57) ABSTRACT

An asset management system implements machine-based management and transfer of digital assets. The system enables creation and storage of digital assets, which can be accessed and/or modified by one or more authenticated users. The asset management system enables designation of one or more inheriting users to have access to the digital asset(s) in the event that a programmatic trigger condition is satisfied. In response to input from a user, the asset management system creates one or more programmatic trigger conditions with various inputs which must be satisfied in order for a digital asset transfer to take place. The asset management system defines one or more actions to take place upon a determination that the programmatic trigger condition(s) is satisfied. Permissions associated with the digital asset(s) can be modified to authorize one or more inheriting users to access the digital assets in a manner authorized by a primary user. A variety of other automated actions can be defined by the system to occur in association with execution of the digital asset transfer.

### CROSS-REFERENCE TO RELATED APPLICATIONS

This application claims priority from and is a continuation of U.S. patent application Ser. No. 14/275,819, “MANAGEMENT OF DIGITAL ASSETS”, Attorney Docket omnetempus.00001.us.n.1, Mauro Marson, filed May 12, 2014, the entire disclosure of which is incorporated by reference herein, in its entirety, for all purposes. U.S. patent application Ser. No. 14/275,819 is co-pending and is related to, and herein incorporates by reference for all purposes the following U.S. patent application: U.S. patent application Ser. No. 14/275,825, “PRESENTATION OF HOMAGE TOKENS”, Attorney Docket omnetempus.00002.us.n.1, Mauro Marson, filed May 12, 2014, the entire disclosure of which is incorporated by reference herein, in its entirety, for all purposes.

### BACKGROUND

The advent of the Internet and cloud storage has created new issues with regards to estate management. Property that was commonly stored in physical format is now increasingly stored and managed digitally in the cloud. In addition to storing digital content in the cloud, many people now maintain some form of an online presence, whether through accounts created on social networking sites or other web services requiring a user to create an account.

Many different systems and protocols exist for securely accessing digital assets across a variety of different platforms and devices. Unfortunately, these systems are not cross-compatible in their ability to transfer or even view assets associated with a common owner or account. Both the management and access to digital assets can be confusing and difficult for the end-user as authentication and permissions functionality is complex and disparate. Furthermore, the systems for access, storage, and modification of digital assets are changing with time. Many systems are rapidly developing and modifying their protocols and features, while others are sunsetting either partially or entirely. Thus, the maintenance of digital assets is difficult for users.

Managing the transfer of digital assets between parties can be even more complicated and cumbersome than managing one's own digital assets. Complicating matters, when one party is deceased or incapacitated, situations arise in which assets can be inaccessible or lost entirely. Thus, the transfer of digital assets stored in heterogeneous systems, formats, and protocols presents an increasingly difficult technical problem for system architects and engineers. While the emergence of the Internet and cloud computing have brought numerous improvements and conveniences in the area of information technology, the management and transfer of assets has become increasingly complex.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for machine-based management and transfer of digital assets. An asset management system can enable creation and storage of digital assets, which can later be accessed, modified, etc., by one or more authenticated users. The asset management system enables designation of one or more inheriting users to have access to the digital asset(s) in the event that a programmatic trigger condition is satisfied.

A primary user can provide information identifying one or more inheriting users. In response to input from a primary user, the asset management system can be configured to create one or more programmatic trigger conditions with various inputs which must be satisfied in order for a digital asset transfer to take place. The primary user can also designate specific digital assets that the inheriting user is to inherit in the event that the programmatic trigger condition(s) is/are satisfied. Confirmation from any number of trusted external sources can be required for satisfaction of the programmatic trigger condition.

The asset management system is configured to define one or more actions to take place upon a determination that the programmatic trigger condition(s) is/are satisfied. For example, permissions associated with the digital asset(s) can be modified to authorize one or more inheriting users to access the digital assets in a manner authorized by the primary user. A variety of other automated actions can be defined by the system to occur in association with execution of the digital asset transfer.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates an exemplary computer system in accordance with embodiments of the present invention;

FIG. 2 illustrates an exemplary embodiment of designating an inheriting user to inherit digital assets;

FIG. 3 illustrates an exemplary embodiment of providing a primary user's digital assets to an inheriting user upon the primary user passing away;

FIG. 4 illustrates an exemplary embodiment of presenting an homage token on a memorial;

FIGS. 5A and 5B illustrate an exemplary embodiment of a memorial for a deceased user;

FIG. 6 illustrates an exemplary embodiment of an interface for managing a user account on an asset management system; and

FIGS. 7A and 7B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for management of digital assets. An asset management system can enable a primary user to create a user account and store digital assets, which can later be accessed, modified, etc., by the primary user. The asset management system can also enable the primary user to designate one or more inheriting users that will be authorized to access the digital assets in the event that the primary user passes away.

The primary user can provide contact information identifying the inheriting users. For example, the primary user can provide contact information such as an e-mail address, or, alternatively, an account identifier associated with the inheriting user's account with the asset management system. The primary user can also designate specific digital assets that the inheriting user is to inherit in the event that the primary user passes away.

Upon a determination that the primary user has passed away, the asset management system can authorize each inheriting user to access the digital assets designated to the inheriting user by the primary user. In some embodiments, the digital assets can be assigned to the inheriting user's account, and accordingly, they can be accessed by the inheriting user. For example, permissions attributes of the digital assets can be modified such that the digital assets are accessible by the inheriting user. In another example, the inheriting user's login credentials can be authorized to access the primary user's account, and thereby access the digital assets. Alternatively, in some embodiments, the inheriting user can be provided with login credentials to access the primary user's account.

Further, the asset management system can also enable creation of a memorial to a deceased individual. For example, a primary user can create their own memorial, which can be published upon the primary user passing away. Alternatively, an inheriting user can create a memorial for the primary user, which can be published when the primary user passes away.

Users can post to the memorial to show respect or homage to the deceased individual. For example, users can post homage tokens, such as digital candles, digital flowers, etc., to the memorial where they can be viewed by other users viewing the memorial. In some embodiments, the posted homage tokens can be associated with an expiration time, after which the posted homage token can be removed from the memorial.

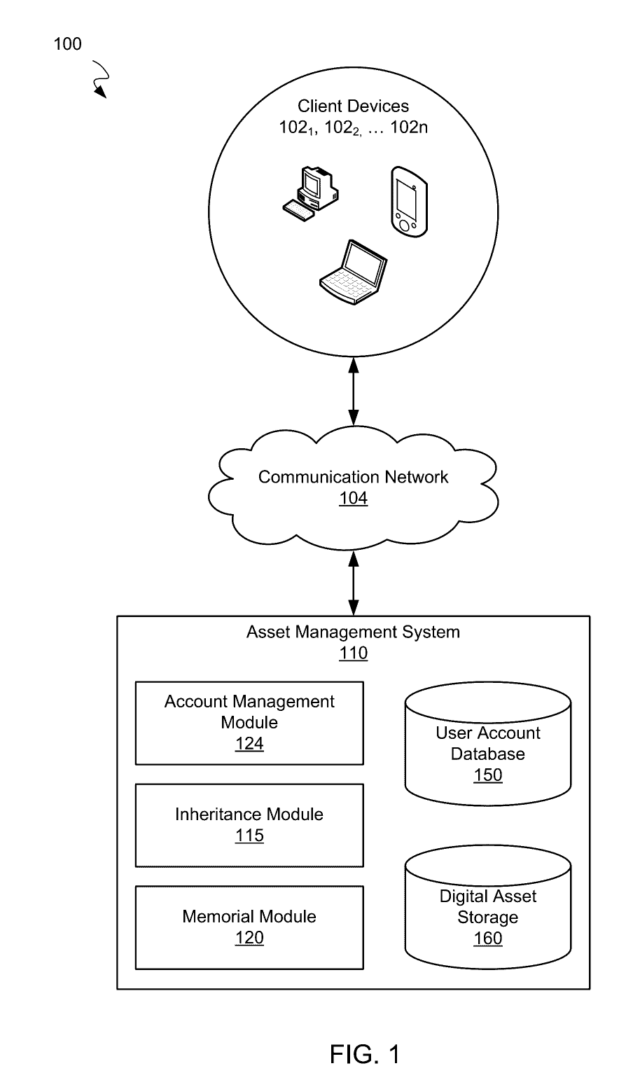

FIG. 1 illustrates an exemplary system configuration 100, wherein electronic devices communicate via a network for purposes of exchanging content and other data. As illustrated, multiple computing devices can be connected to a communication network 104 and be configured to communicate with each other through the use of the communication network 104.

A communication network 104 can be any type of network, including a local area network (“LAN”), such as an intranet, a wide area network (“WAN”), such as the internet, or any combination thereof. Further, a communication network 104 can be a public network, a private network, or a combination thereof. A communication network 104 can also be implemented using any number of communications links associated with one or more service providers, including one or more wired communication links, one or more wireless communication links, or any combination thereof. Additionally, a communication network 104 can be configured to support the transmission of data formatted using any number of protocols.

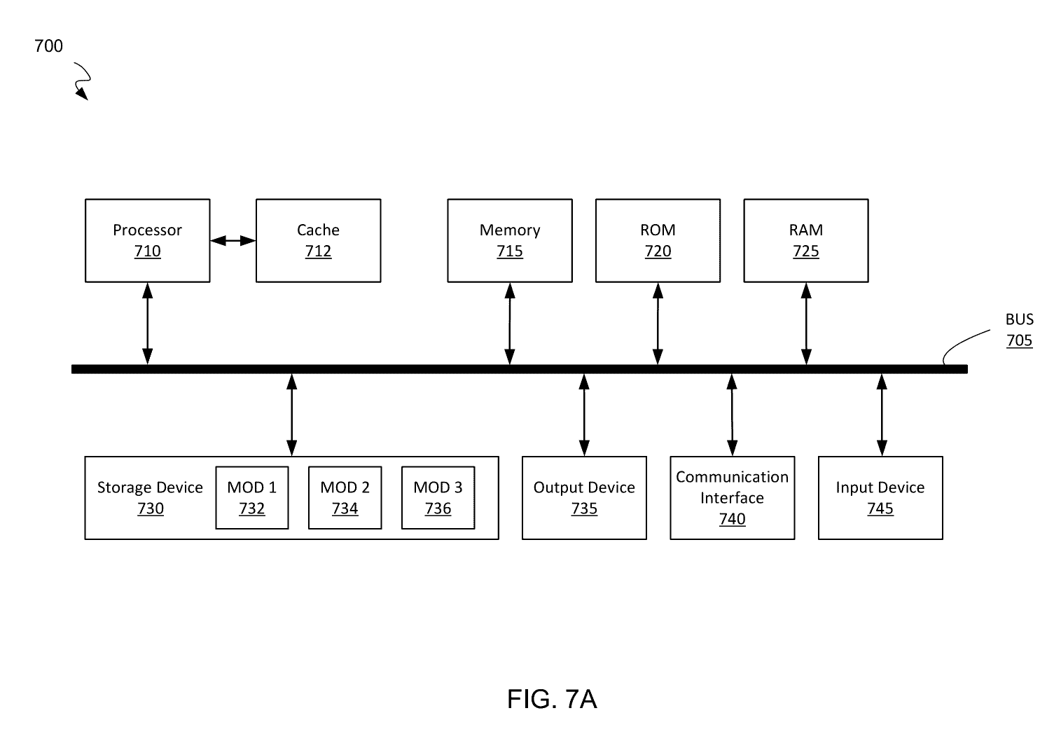

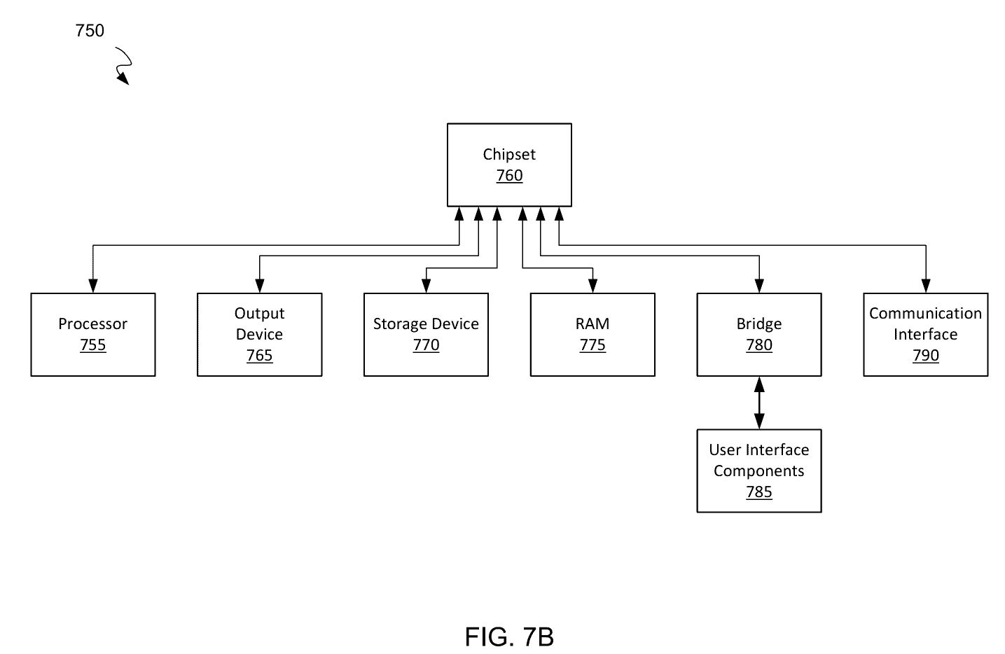

Multiple computing devices can be connected to a communication network 104. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 7 of FIGS. 7A and 7B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As illustrated, the system 100 includes client devices 102₁ . . . 102ₙ (collectively “102”) and an asset management system 110, connected to a communication network 104 to communicate with each other to transmit and receive data. The asset management system 110 can be configured to manage digital assets for user accounts. This can include storing digital assets and enabling a user to access the digital assets.

A user can interact with the asset management system 110 through the client devices 102 connected to the network 104 by direct and/or indirect communication. The asset management system 110 can support connections from a variety of different client devices 102, such as desktop computers; mobile computers; mobile communications devices, e.g. mobile phones, smart phones, tablets; smart televisions; set-top boxes; and/or any other network enabled computing devices. The client devices 102 can be of varying type, capabilities, operating systems, etc. Furthermore, the asset management system 110 can concurrently accept connections from and interact with multiple client devices 102.

A user can interact with the asset management system 110 via a client-side application installed on a client device 102ᵢ. In some embodiments, the client-side application can include an asset management system-specific component. For example, the component can be a stand-alone application, one or more application plug-ins, and/or a browser extension. However, the user can also interact with the asset management system 110 via a third-party application, such as a web browser, that resides on a client device 102ᵢ and is configured to communicate with the asset management system 110. In either case, the client-side application can present a user interface (UI) for the user to interact with the asset management system 110. For example, the user can interact with the asset management system 110 via a client-side application integrated with the file system or via a webpage displayed using a web browser application.

The asset management system 110 includes functionality to allow a user to store digital assets on the asset management system 110, as well as perform a variety of digital asset management tasks, such as retrieve, modify, browse, and/or share the digital assets. Furthermore, the asset management system 110 includes functionality to allow a user to access the digital assets from multiple client devices 102. For example, a client device 102ᵢ can upload digital assets to the asset management system 110 via the communication network 104. The digital assets can later be retrieved from the asset management system 110 using the same client device 102 or some other client device 102ⱼ.

To facilitate the various digital asset management services, a user can create a user account with the asset management system 110. The account information can be maintained in a user account database 150. The user account database 150 can store account information for registered users. In some cases, the only personal information in the user account can be a username and/or email address. However, asset management system 110 can also be configured to accept additional user information.

The user account database 150 can also include account management information, such as user account type, e.g. free or paid; usage information, e.g. file edit history; maximum storage space authorized; storage space used; digital asset storage locations; security settings; personal configuration settings; digital asset sharing data; etc. The account management module 124 can be configured to update and/or obtain user account details in the user account database 150. The account management module 124 can be configured to interact with any number of other modules in the asset management system 110.

A user account can be used to store digital assets from one or more the client devices 102 authorized on the user account. Digital assets can be stored in the digital asset storage 160. The digital assets can include but are not limited to digital data, documents (e.g., legal documents such as wills, trust agreements, etc.), text files, image files, audio files, video files, digital currency, etc. The digital assets can also include folders of various types with different behaviors, or other mechanisms of grouping digital assets together. For example, a user account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos (e.g., a web album interface to provide the photos for public viewing); an audio folder that provides the ability to play back audio files and perform other audio related actions; or other special purpose folders. A user account can also include shared folders or group folders that are linked with and available to multiple user accounts. The permissions for multiple users may be different for a shared folder.

In some embodiments, digital assets for the primary user, but not uploaded directly by the primary user, can be stored in the digital asset storage 160. For example, the asset management system 110 can request information from the primary user and store information provided by the primary user in a digital asset. In a more specific example, the asset management system 110 may present the primary user with a questionnaire asking about confidential information of the primary user related to external accounts (e.g., username and password for a stock trading website or an online banking website), files (e.g., passwords to password-protected files on a computer device of the primary user), or otherwise (e.g., bank account information or the combination on a padlock), and store answers to the questions in a digital asset created by the asset management system 110 in response to the questionnaire. The digital asset may be a proprietary file format dedicated to storing such confidential information. In other embodiments, the information gathered directly from the primary user or indirectly from the primary user (e.g., through sources related to the primary user), may be stored in other formats (e.g., in a relational database).

The digital asset storage 160 can be a storage device, multiple storage devices, or a server. Alternatively, the digital asset storage 160 can be a cloud storage provider or network storage accessible via one or more communications networks. The asset management system 110 can hide the complexity and details from the client devices 102 so that information identifying exactly where the digital assets are being stored by asset management system 110 is not shared with the client device 102. In one variation, the asset management system 110 can store the digital assets in the same folder hierarchy as they appear on a client device 102ᵢ. However, the asset management system 110 can store the digital assets in a different order, arrangement, or hierarchy. The asset management system 110 can store the digital assets in a network accessible storage (SAN) device, in a redundant array of inexpensive disks (RAID), etc. Digital asset storage 160 can store digital assets using one or more partition types, such as FAT, FAT32, NTFS, EXT2, EXT3, EXT4, ReiserFS, BTRFS, and so forth.

The digital asset storage 160 can also store metadata describing digital assets, digital asset types, and the relationship of digital assets to various user accounts, folders, or groups. The metadata for a digital asset can be stored as part of the digital asset or can be stored separately. In one variation, each digital asset stored in the digital asset storage 160 can be assigned a system-wide unique identifier.

In some embodiments, the asset management system 110 can be configured to encrypt the digital assets stored in a user account. Adding encryption to the digital assets can provide an additional layer or protection and security for the digital assets. Further, in some embodiments, the asset management system 110 can be configured to back up the digital assets. For example, the digital assets can be backed up to remote file servers, disk, etc. In some embodiments, a user can select whether to include encryption and/or backup capability to their user account. For example, a user can pay a specified fee to upgrade their user account to add encryption and/or backup capability.

In some embodiments, the asset management system 110 can be configured to manage the digital asset in a user account in the event that the primary user associated with the user account passes away. For example, the asset management system 110 can be configured to determine that the primary user has passed away and authorize the appropriate inheriting users to access the digital assets. A primary user can be the user that created the user account and has authorization to access the user account.

In some embodiments, the asset management system 110 can be configured to enable a primary user to select one or more inheriting users that, in the event that the primary user passes away, can inherit the primary user's digital assets, meaning that the digital assets will become the property of the inheriting user. Initially, the primary user will be the only user authorized to access the digital assets in the primary user's account on the asset management system 110. Upon confirmation of the primary user's death, the inheriting users can be authorized to access the primary user's digital assets stored on the asset management system 110, thus transferring ownership of the digital assets to the inheriting users.

To accomplish this, the asset management system 110 can include an inheritance module 115 configured to enable a user to assign one or more inheriting users to inherit the primary user's digital assets. For example, the inheritance module 115 can be configured to prompt a primary user to enter information identifying one or more inheriting users.

In some embodiments, the inheritance module 115 can be configured to prompt a primary user to enter contact information for an inheriting user. For example, a primary user can enter an e-mail address, phone number, etc., for an inheriting user. Alternatively, in some embodiments, the inheritance module 115 can be configured to prompt a user to enter user account information for an inheriting user. For instance, an inheriting user may have an existing account with the asset management system 110, and the inheritance module 115 can prompt the primary user to enter account information identifying the user account of the inheriting user, such as an account number, user name, etc.

In some embodiments, the inheritance module 115 can determine if an inheriting user has an existing user account with the asset management system 110. For example, the inheritance module 115 can prompt a primary user to enter contact information identifying an inheriting user, and the inheritance module 115 can use this information to determine if there is an existing user account associated with the received contact information. To accomplish this, the inheritance module 115 can search the user account data in the user account database 150 to determine if an existing user account includes contact information matching the contact information provided by the primary user.

In some embodiments, the inheritance module 115 can be configured to notify an inheriting user that they have been designated as an inheriting user for the primary user's user account. For example, the inheritance module 115 can use contact information, such as an e-mail address, provided by the primary user to contact the inheriting user at the provided e-mail address. Alternatively, if a primary user provided data identifying the inheriting user's account with the asset management system 110, the inheritance module 115 can gather the inheriting user's contact information from the user profile and contact the inheriting user.

In some embodiments, the inheritance module 115 can notify the inheriting user that the inheriting user has been designated as an inheriting user by the primary user. For example, the inheritance module 115 can send the inheriting user a message notifying the inheriting user that the primary user has designated the inheriting user to inherit digital assets of the primary user in the event that the primary user passes away.

In some embodiments, the inheritance module 115 can further prompt the inheriting user to create a user account with asset management system 110. For instance, the asset management system 110 can be configured to require that an inheriting user have a user account with the asset management module 110 to inherit the primary user's digital assets in the event that the primary user passes away. The inheritance module 110 can transmit the inheriting user a message prompting the inheriting user to create a user account.

In some embodiments, the inheritance module 115 can prompt the inheriting user to create a standard user account such that the inheriting user is the primary user of the newly created user account. Alternatively, in some embodiments, the inheritance module 115 can prompt the inheriting user to create an inheriting user account with limited functionality that enables the inheriting user to inherit the primary user's digital assets, but does not include the other functionality of a standard user account, such as storing digital assets, designating inheriting users, etc., although the inheriting user can choose to create a standard user account if desired.

In some embodiments, the inheritance module 115 can require an inheriting user to acknowledge or accept being an inheriting user for a primary user's account. For example, the inheritance module 115 can require an inheriting user to read the terms of agreement and acknowledge acceptance of the presented terms as well as the responsibilities associated with being an inheriting user for the primary user's account. Further, the inheritance module 115 can enable an inheriting user to decline the primary user's designation as an inheriting user. For example, the inheritance module 115 can present the user with a user interface element, such as a button, that when selected, indicates that the inheriting user decline the invitation to be an inheriting user for the primary user's account.

If an inheriting user does decline the invitation to be an inheriting user for the primary user's account, the inheritance module 115 can be configured to notify the primary user of the inheriting user's decision. For example, the inheritance module 115 can transmit a notification to the primary user notifying the primary user of the inheriting user's decision to decline. The inheritance module 115 can further prompt the primary user to identify a substitute inheriting user.

The inheritance module 115 can store information regarding a designated inheriting user and associate the information with the primary user's account. For example, the inheritance module 115 can store the inheriting user's contact information in the user account database 150 and associate the contact information with the primary user's account. Alternative, the inheritance module 115 can store the inheriting user's information in the inheriting user's account in the user account database 150 and associate the inheriting user's account with the primary user's account. For example, the inheritance module 115 can store an account identifier identifying the inheriting user's account in the primary user's account in the user account database 150.

Designating an inheriting user can result in the inheriting user being provided authorization to access the primary user's digital assets on the asset management system 110 in the event that the primary user passes away. For example, in some embodiments, the inheritance module 115 can transmit the inheriting user log in credentials to access the primary user's account upon the primary user passing away. Alternatively, in some embodiments, the inheritance module 115 can authorize an inheriting user's account to access the primary user's digital assets upon the primary user passing away. An inheriting user can thus use their login credential to login to their user account, where they can access the primary user's digital assets.

The inheritance module 115 can determine whether a primary user has passed away in numerous ways. For example, in some embodiments, the inheritance module 115 can enable a primary user to designate one or more trusted users that are trusted to notify the asset management system 110 that the primary user has passed away. For example, a primary user can designate a person that the primary user trusts, such as an attorney, friend, family member, etc., as a trusted person that is authorized to notify the asset management system 110 that the primary user has passed away, thus triggering the inheritance module 115 to provide an inheriting user access to the primary user's digital assets.

In some embodiments, the inheritance module 115 can enable a primary user to select any user to be a trusted user without restriction. Alternatively, in some embodiments, the inheritance module 115 can restrict the primary user to select a trusted user that is not an inheriting user for the primary user's account. A conflict of interest can arise if an inheriting user is also a trusted user because the inheriting user can cause the transfer of the primary user's digital assets to his/herself. To avoid this potential conflict of interest, the inheritance module 115 can restrict the users that are eligible to be designated as a trusted user to users that are not inheriting users.

To designate a trusted user, in some embodiments, the inheritance module 115 can require the primary user to enter contact information for the trusted user. For example, the inheritance module 115 can require the primary user to provide an e-mail address, phone number, address, etc., for the trusted user. Alternatively, in some embodiments, the inheritance module 115 can prompt a user to enter account information for the trusted user. For example, the primary user can designate a trusted user that has an existing account with the asset management system 110 by entering account information identifying the trusted user's account, such as an account identifier and/or username.

In some embodiments, the inheritance module 115 can contact a trusted user to notify the trusted user that they have been designated as a trusted user for the primary user's account. For example, the inheritance module 115 can transmit a notification message to the trusted user using the contact information provided by the primary user, or, alternatively, know contact information for the trusted user gathered from the trusted user's account.

In some embodiments, the inheritance module 115 can enable a trusted user to agree or decline to be a trusted user for the primary user's account. For example, the inheritance module 115 can provide the trusted user with a user interface element, such as a button, that when selected, indicates that the trusted user declined to be a trusted user for the primary user's account. Likewise, the inheritance module 115 can provide the trusted user with a user interface element that, when selected, indicates that the trusted user accepts the responsibility of being a trusted user for the primary user's account. This can include requiring the trusted user to read and accept terms and conditions associated with being a trusted user.

A trusted user can be trusted to notify the asset management system 110 that a primary user has passed away, thus causing the primary user's digital assets to be transferred to the inheriting users. In some embodiments, the inheritance module 110 can require a trusted user to notify the asset management system 110 that a primary user has passed away using a designated contact method. For example, the trusted user can be required to transmit a message from an e-mail address provided by the primary user for the trusted user. Alternatively, the trusted user can be required to make a phone call from a specified phone number, such as a number provided by the primary user.

In some embodiments, the trusted user can be required to transmit a message from their user account with the asset management system 110. For example, the inheritance module 115 can require that a trusted user have a valid account with the asset management system 110 to be designated as a trusted user. The inheritance module 115 can enable a user to indicate that a primary user has passed away from their user account. For example, upon logging into their user account, a trusted user can be presented with a user interface element that, when selected, indicates that a primary user has passed away. Alternatively, in some embodiments, the inheritance module 115 can enable a trusted user to transmit a message from their user account indicating that the primary user has passed away. The message can be sent to an administrator of the asset management system 110.

In some embodiments, the inheritance module 115 can determine that a primary user has passed away by receiving one or more trusted documents. A trusted document can be a document predetermined to be trusted to indicate that the primary user has passed away. For example, a trusted document can be an official copy of a death certificate. Upon receiving the death certificate, the inheritance module 115 can determine that the primary user has passed away.

Alternatively, in some embodiments, the trusted document can be an affidavit indicating that the primary user has passed away. For example, the affidavit can be received from an inheriting user, trusted user, other family member, government official, etc. In some embodiments, the inheritance module 115 can require that the trusted document, such as an affidavit, be received from or be executed by a specified person or a person from a group of specified people, to be accepted as a valid confirmation that the primary user has passed away.

In some embodiments, the inheritance module 115 can require multiple forms of confirmation that a primary user has passed away. For example, a trusted user can be required to confirm that a primary user has passed away using two or more of the contact methods described above. For example, a trusted user can be required to login to their user account on the asset management system 110 to indicate that a primary user has passed away. The inheritance module 115 can then require the trusted user to confirm that the primary user has passed away using one or more of the contact methods provided for the user. For example, the inheritance module 115 can send a confirmation message to the trusted user via an e-mail address or phone number of the trusted user. The confirmation message can require the trusted user to confirm that the primary user has passed away, for example, by responding to the confirmation message, providing a specified input, etc.

In some embodiments, the inheritance module 115 can require confirmation from multiple trusted users that a primary user has passed away. For example, the inheritance module 115 can require a primary user to designate two or more and trusted users and multiple users must notify the asset management system 110 that a primary user has passed away for the inheritance module 115 to determine that the primary user has passed away, causing the primary user's digital assets to be passed to the inheriting users.

In some embodiments, the inheritance module 115 can determine that a primary user has passed away based on information provided from a third party service/source. For example, a third party trusted service can confirm that a primary user has passed away and transmit a message to the asset management system 110 indicating that the primary user has passed away. In some embodiments, the third party service can notify the asset management system 110 when a primary user has passed away. In some embodiment, the asset management system 110 can query the third party service regarding whether a specified primary user has passed away. For example, the inheritance module 115 can be configured to periodically query the third party service regarding the status of one or more primary users.

Alternatively, the inheritance module 115 can query the third party service upon a specified trigger occurring. For example, the inheritance module 115 can query the third party service after receiving a notification that a primary user has passed away, such as a notice received from a trusted user. Alternatively, the inheritance module 115 can query the third party service upon a determination that a primary user has not logged into their user account for a specified amount of time. For example, the inheritance module 115 can query the third party service regarding the status of the primary user if the primary user has not logged into their user account in six months, a year, etc.

In some embodiments, the inheritance module 115 can transmit proof of life messages to a primary user requesting confirmation from the primary user that the primary user has not passed away. For example, the inheritance module 115 can transmit a proof of life message to the primary user every six months, year, etc. If a primary user does not respond to the proof of life message confirming that the primary user is still alive, the inheritance module 115 can determine that the user has passed away or, alternatively, initiate a secondary query regarding the status of the primary user. For example, the inheritance module 115 can query a third party service or a trusted user regarding the status of the primary user.

Upon a determination that the primary user has passed away, the inheritance module 115 can be configured to transfer the primary user's digital assets to an inheriting user. For example, in some embodiments, the inheritance module 115 can reassign the digital assets from the primary user's account to the inheriting user's account. Alternatively, in some embodiments, the inheritance module 115 can enable the inheriting user's account to access the contents of the primary user's account. In some embodiments, the inheritance module 115 can send a message to the inheriting user that includes login credentials enabling the inheriting user to login to the primary user's account and access the digital assets.

In some embodiments, the inheritance module 115 can transfer all of the primary user's digital assets to one or more inheriting users. Alternatively, in some embodiments, the inheritance module 115 can enable a primary user to select the digital assets that are transferred to each inheriting user. For example, a primary user may wish to disperse some digital assets to one inheriting user and some other digital assets to other inheriting users.

To accomplish this, the inheritance module 115 can be configured to enable a primary user to designate the inheriting user that will receive a digital asset upon the primary user's death. The inheritance module 115 can maintain a record of the inheriting user assigned to each digital asset. For example, in some embodiments, the inheritance module 115 can maintain an inheritance index that lists each digital asset along with the inheriting user that will receive the digital asset upon the primary user's death. Alternatively, in some embodiments, the inheritance module 115 can attach metadata to a digital asset that identifies the inheriting user designated to receive the digital asset.

In some embodiments, the inheritance module 115 can be configured to enable a primary user to create a directory that is designated to a specified inheriting user. For example, a primary user can create a multiple directories and assign each directory to a different inheriting user. The primary user can then place digital assets into the various directories to assign the digital asset to a selected inheriting user. Upon confirmation that the primary user has passed away, the inheritance module 115 can authorize an inheriting user to access all of the digital assets in the directory assigned to the inheriting user.

In addition to managing digital assets upon a primary user's death, in some embodiments, the asset management system 110 can be configured to provide an online memorial for a primary user. For example, digital assets, such as files, images, audio, etc., can be stored in a public folder in the primary user's account to create a memorial for the primary user that can be publicly accessed.

In some embodiments, the asset management system 110 can include a memorial module 120 configured to create a memorial for a primary user. The memorial module 120 can provide tools and templates for creating a memorial for a primary user. For example, the memorial module 120 can provide a memorial creation interface enabling a user to create and customize a memorial. In some embodiments, the memorial creation interface can enable a user to select available memorial templates and customize the selected memorial template by entering text, images, etc.

In some embodiments, the memorial creation interface can enable a user to select images, audio, video, etc., stored in the primary user's account to include in the memorial. Alternatively, the memorial creation interface can enable a user to upload images, audio, video, etc., from the user's client device to include in the memorial.

In some embodiments, the memorial module 120 can enable a primary user to create their own memorial, which will not be published until the primary user has passed away. For example, a primary user can use the memorial creation interface to create a memorial that will remain private at least until asset management system 110 determines that the primary user has passed away.

In some embodiments, the memorial module 120 can be configured to publish the primary user's memorial upon a determination that the primary user has passed away. Alternatively, in some embodiments, the memorial module 120 can require that an inheriting user select or recommend to an inheriting user to select to publish the memorial upon after the death of the primary user. This type of embodiment allows an inheriting user to complete the memorial prior to the memorial being published and made publicly available.

Alternatively, a user other than the primary user can also create and publish a memorial for the primary user. For example, an inheriting user can create a memorial for the primary user after the primary user passes away. In some embodiments, the primary user can designate the inheriting user that can be granted authorization to create and publish a memorial for the primary user.

In some embodiments, an inheriting user can create a memorial for the primary user prior to the primary user passing away. For example, an inheriting user can login to their user account and create a memorial for the primary user with the memorial creation interface. While the inheriting user can create a memorial for a primary user prior to the primary user passing away, in some embodiments, the memorial module 120 can be configured to restrict the inheriting user from publishing the memorial until it is determined that the primary user has passed away.

In some embodiments, the asset management system 110 can be configured to enable users to post messages, images, audio, etc., to a primary user's memorial after the memorial has been published and made publicly available. For example, friends of the primary user may wish to post comments, images, etc., to show respect or homage to the passing of their friend. Memorial comments, images, etc., posted to the primary user's memorial can be presented along with the memorial and made publicly available to other users that view the memorial.

In some embodiments, the memorial module 120 can be configured to enable users to post an homage token to a published memorial. An homage token can be a token posted to show respect or homage to a primary user that has passed away. In some embodiments, an homage token can be an icon or image of an item that is commonly left at a live memorial, such as a candle, flower, picture, etc. An homage token posted to a published memorial can be presented on the memorial and viewed by other users viewing the memorial. For example, an homage token depicting a candle can be presented on the primary user's memorial.

In some embodiments, the memorial module 120 can be configured to remove an homage token posted to a memorial after a predetermined amount of time passing after the homage token has been posted. For example, an homage token can have an expiration time based on the time the homage token is posted to a memorial, such as one hour, one day, one week, etc., after the homage token is posted, after which the homage token is removed from the memorial. The memorial module 120 can be configured to track the amount of time that has elapsed after an homage token has been posted to a memorial and determined that an homage token has expired when the predetermined amount of time has elapsed after the homage token was posted to the memorial. Upon a determination that an homage token has expired (e.g., the predetermined amount of time has elapsed after the homage token was posted to the memorial), the memorial module 120 can remove the homage token from the memorial such that the homage token is no longer visible to users viewing the memorial.

In some embodiments, the expiration time associated with an homage token (e.g., the predetermined amount of time that must elapse after the homage token is posted to a memorial for the homage token to expire) can be variable. For example, the expiration time associated with an homage token can be based on the type of object depicted by the homage token. For example, an homage token depicting a candle can be associated with a different expiration time than an homage token depicting flowers.

In some embodiments, the expiration time can be based on the expected life of the object depicted by the homage token. For example the expiration time associated with a candle can be based on a time that a real candle would last before burning out. Likewise, the expiration time associated with an homage token depicting flowers can be based on a time that real flowers would last before wilting.

In some embodiments, the expiration time associated with an homage token can be based on the depicted size of the homage token. For example, the expiration time associated with an homage token depicting a large candle can be longer than the expiration time associated with an homage token depicting a smaller candle.

In some embodiments, the expiration time associated with an homage token can be based on an amount of money paid by a user to post the homage token to a memorial. The memorial module 120 can require a user to pay a predetermined amount of money to post an homage token, or alternatively, to post a ‘premium’ homage token to a memorial. The expiration time associated with an homage token can be based on the amount of money paid by a user to post the homage token such that the more money that a user pays to post an homage token, the longer the expiration time associated with the homage token. In some embodiments, a user can renew the homage token before or after it reaches its expiration time, such that the homage token will continue to exist on the memorial until it reaches a second expiration time later than the original expiration time. Users may renew the homage token manually (e.g., after receiving an expiration notification) or set up an auto-renewal mechanism. Further, in some embodiments, a user can pay a specified amount to remove the expiration restriction from the homage token completely, and as a result the posted homage token may never expire.

In some embodiments, payment made toward an homage token or options of an homage token can be based on advertisements. For example, instead of receiving a monetary amount from a user for an homage token, the user can be required to watch one or more advertisements. Alternatively, a user can post an homage token that includes an advertisement. For example, to post an homage token representing flowers, the memorial module 120 can require the user to allow an homage token to include an advertisement for a flower service. For example, the homage token can include a link to the flower service's website. Alternatively, the homage token can display a logo or other indicator for the flower service.

In some embodiments, the size of the object depicted by an homage token and/or the type of object represented by an homage token can be based on the amount of money that a user pays to post the homage token to a memorial. For example, the more money the user pays, the larger the object depicted by the homage token, which can be associated with a longer expiration time than a smaller homage token. Likewise, in some embodiments, homage tokens can be based with varying costs based on the object depicted by the homage token. For example, homage tokens depicting flowers can be associated with a higher cost to post to a memorial than the cost to post an homage token depicting a candle.

In some embodiments, the memorial module 120 can be configured to modify the appearance of an homage token to indicate how much time remains until the homage token expires. For example, the memorial module 120 can indicate that an homage token depicting a candle is nearing its expiration time by modifying the appearance of the homage token to depict the candle becoming shorter and thus closer to burning out. Likewise, the memorial module 120 can indicate that an homage token depicting flowers is nearing its expiration time by modifying the appearance of the homage token to depict that the flowers are wilting.

In some embodiments, the memorial module 120 can modify the size of the homage token based on the expiration time of the homage token. For example, the homage token can represent an image such as a candle and the memorial module 120 can modify the size of the candle depicted by the homage token to appear as if the candle is burning down. In another example, the memorial module 120 can modify the size of the image of the homage token such that the image decreases in size until it disappears when the homage token expires.

In some embodiments, the memorial module 120 can be configured to provide a selection of ‘premium’ homage tokens that are only available for purchase. For example, the premium homage tokens can depict specified images, objects, etc., that are considered of higher value and hence are worth an additional cost to be posted. In some embodiments, premium homage tokens can include an animation, video, or other advanced feature, whereas free homage tokens can be limited to static images.

In some embodiments, a premium homage token can be customizable, whereas free homage tokens are not customized. For example, a premium homage token can include functionality enabling a user to customize a text portion, image, audio, etc. of the premium homage token. Although characteristics such as expiration times, appearance modifications, customizations, etc., have been used to differentiate a premium homage token from a free homage token, these are just examples and are not meant to be limiting. One skilled in the art would recognize that an homage token can be designed to provide any type of additional functionality or improved characteristic over a free homage token and this disclosure appreciates all such embodiments.

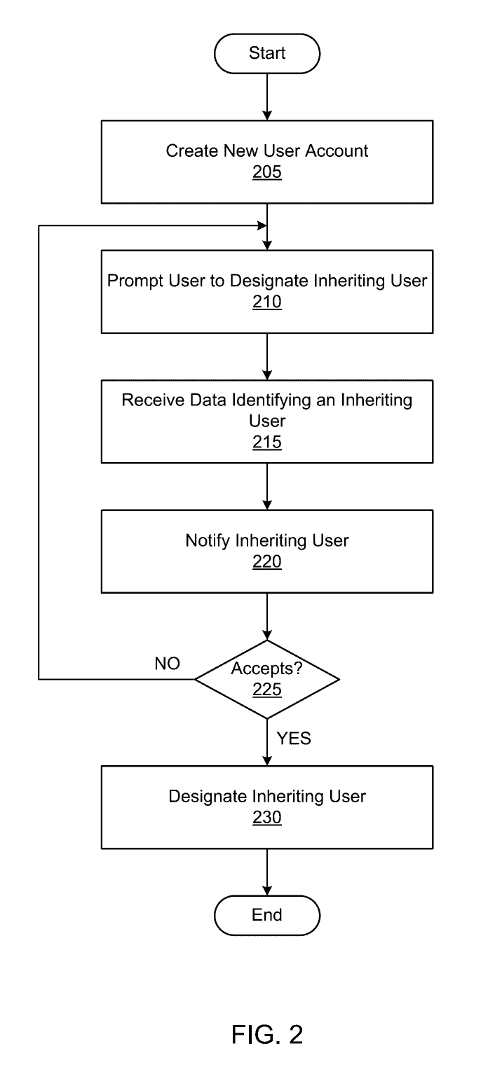

FIG. 2 illustrates an exemplary embodiment of designating an inheriting user to inherit digital assets. Although specific steps are show in FIG. 2, in other embodiments the method can have more steps, less steps, and/or steps in a different order. As shown, the method begins at block 205 where a new user account on an asset management system is created. A user account on the asset management system can be an account that enables a primary user of the user account to store and manage digital assets. For example, the primary user can access the asset management system using login credentials associated with the primary account, and upload, download, access, edit, etc., digital media assets.

The method then continues to block 210 where the primary user is prompted to designate an inheriting user to inherit one or more of the digital assets stored in the primary user's account. In some embodiments, the primary user can be prompted to enter contact information for the inheriting user. In some embodiments, the primary user can be prompted to enter account information identifying the inheriting user's account with the asset management system. For example, the primary user can be prompted to enter an account identifier, username, etc., that identifies the inheriting user's account.

The method then continues to block 215 where the data identifying an inheriting user is received. Upon receiving the data identifying the inheriting user, the method continues to block 220 where the identified inheriting user is notified that they have been designated as an inheriting user for the primary user's account. For example, the inheriting user can be contacted using the contact information for the inheriting user provided by the primary user. The notification can notify the inheriting user that the inheriting user has been designated to inherit one or more digital assets of the primary user's account. Further, the notification can query the inheriting user regarding whether the inheriting user would like to be designated as an inheriting user for the primary user's account.

The method then continues to block 225 where it is determined whether the inheriting user accepted designation as an inheriting user for the primary user's account. If at block 225 it is determined that the inheriting user declined being designated as an inheriting user for the primary user's account, the method returns to block 210 where the primary user is prompted to enter data identifying an inheriting user.

Alternatively, if at block 225 it is determined that the primary user accepts to being an inheriting user for the primary user's account, the method continues to block 230 where the inheriting user is designated as an inheriting user for the primary user's account. The method may then end.

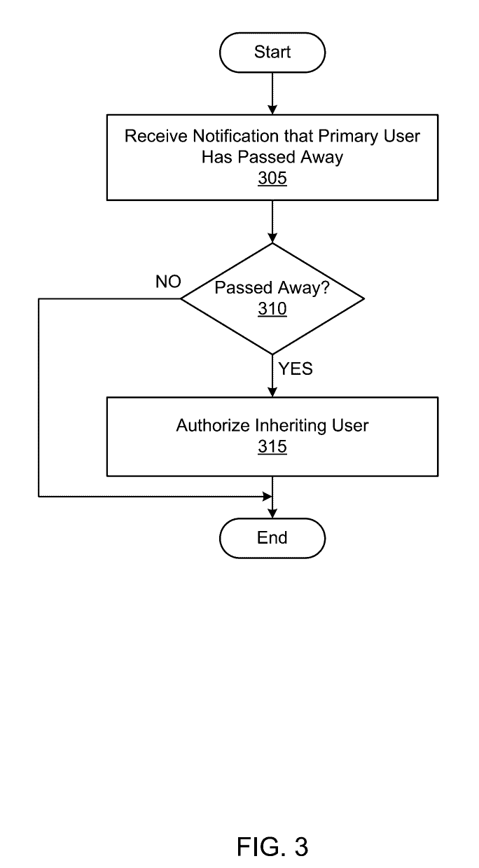

FIG. 3 illustrates an exemplary embodiment of providing a primary user's digital assets to an inheriting user upon the primary user passing away. Although specific steps are show in FIG. 3, in other embodiments the method can have more steps, less steps, and/or steps in a different order. As show, the method begins at block 305 where a notification is received that the primary user of a user account has passed away.

In some embodiments, the notification can be received from a trusted user. A trusted user can be a user designated by the primary user as trusted to notify the asset management system when the primary user has passed away. For example, a primary user can designate an attorney as a trusted user.

In some embodiments, the notification can be received from a trusted third party service. For example, a trusted third party service can be periodically queried regarding whether the primary user has passed away. If the primary user has passed away, the third party service can transmit the notification that the primary user has passed away. Alternatively, in some embodiments, the third party service can transmit the notification that the primary user has passed away without being queried regarding the status of the primary user.

Upon receiving the notification that the primary user has passed away, the method continues to block 310 where it is determined whether the primary user has passed away. In some embodiments, the notification received can be sufficient to determine that the primary user has passed away, however further authentication measures can also be taken to determine whether the primary user has passed away.

In some embodiments, a confirmation message can be sent to determine whether the primary user has passed away. For instance, a confirmation message can be sent to a trusted user or a trusted third party service. If a confirmation that the primary user has passed away is returned in response to the confirmation message, it can be determined that the primary user has passed away.

In some embodiments, a proof of life message can be sent to the primary user. For example, a proof of life message can be sent using one or more known contact methods for reaching the primary user. The proof of life message can request that the primary user respond confirming that the primary user is alive. If a response is not received within a predetermined amount of time after transmitting the proof of life message, it can be determined that the primary user has passed away.

If at block 310 it is determined that the primary user has not passed away. The method ends. Alternatively, if it is determined that the primary user has passed away, the method continues to block 315 where an inheriting user is authorized to access digital contents of the primary user.

In some embodiments, a message including login credentials to access the primary user's account can be transmitted to the inheriting user. The inheriting user can then use the received login credentials to login to the primary user's account and access the primary user's digital assets.

Alternatively, in some embodiments, the primary user's digital assets can be assigned to the inheriting user's account. The inheriting user can then access the digital assets from the inheriting user's account. In some embodiments, the inheriting user's login credentials can be authorized to access the primary user's account. The inheriting user can then user their login credentials to login to the primary user's account and access the digital assets. The method may then end.

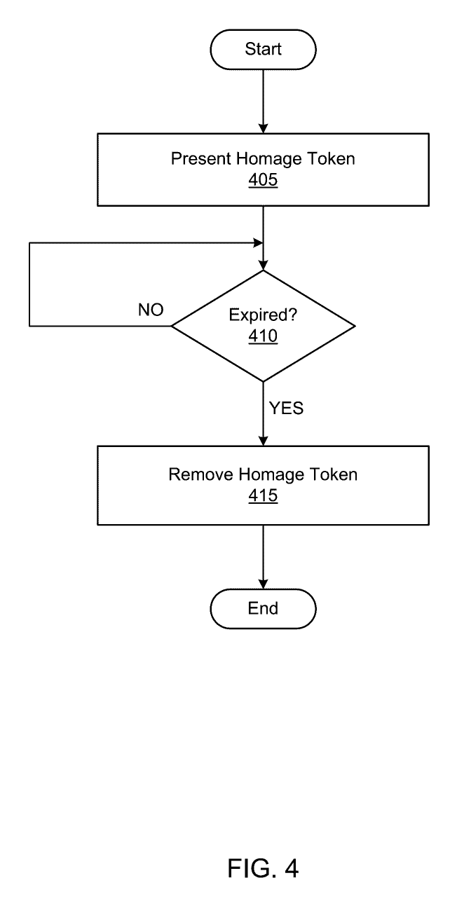

FIG. 4 illustrates an exemplary embodiment of presenting an homage token on a memorial. Although specific steps are show in FIG. 4, in other embodiments the method can have more steps, less steps, and/or steps in a different order. As shown, the method begins at block 405 where an homage token is presented on a memorial. A user can select to post an homage token on a memorial as a sign of respect or homage for the deceased individual. The posted homage token can be presented on the memorial where it can be viewed by other users viewing the memorial.

Upon presenting the homage token on the memorial, the method continues to block 410 where it is determined whether the homage token has expired. An homage token can be associated with an expiration time indicating an amount of time that the homage token remains valid, after which the homage token is removed from the memorial. If at block 410 it is determined that the homage token has expired (e.g., a predetermined amount of time has elapsed since the homage token was posted to the memorial), the method continues to block 415 where the homage token is removed from the memorial. The method may then end.

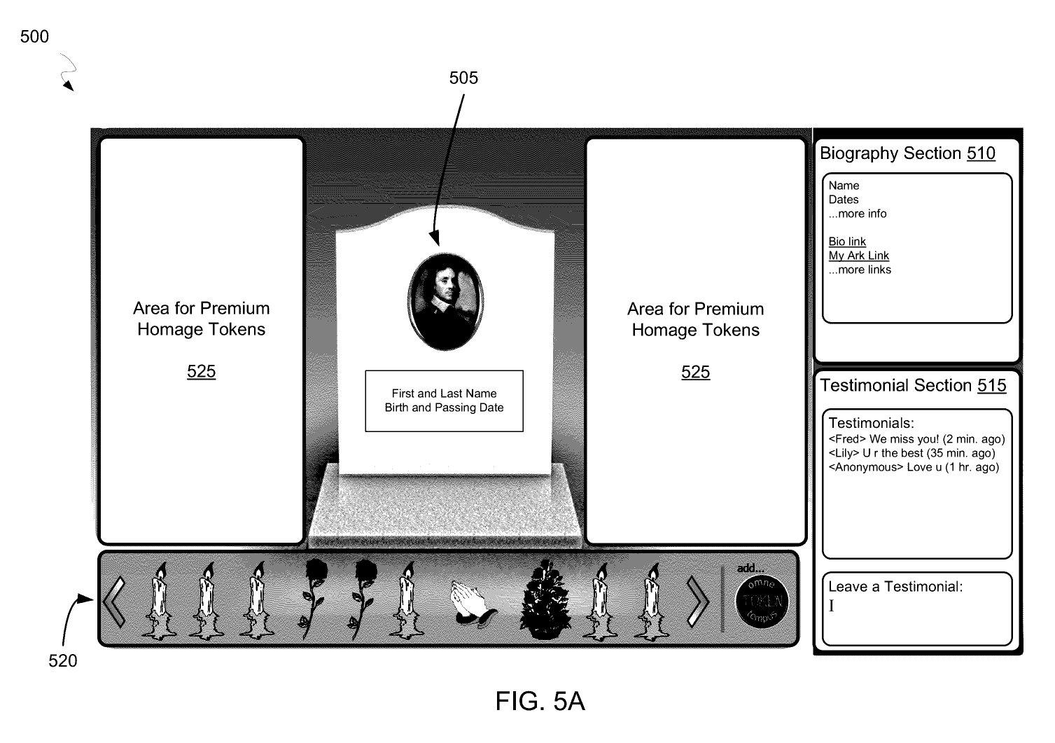

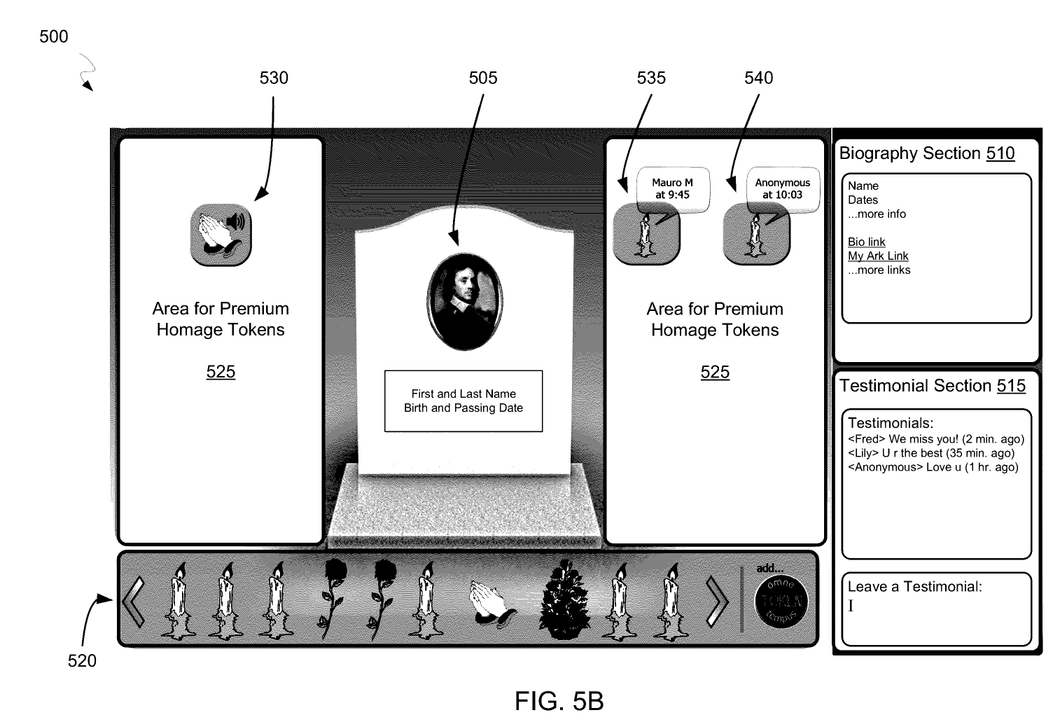

FIG. 5A illustrates an exemplary embodiment of a memorial for a deceased user. As shown, a memorial 500 can include an image of a deceased user 505 as a central focus of the memorial. The memorial 500 can further include a biography section 510 that includes additional information about the deceased user 505. For example, the biography section 510 can included the deceased user's name, birthdate, date of death, a biography about the deceased user, etc.

The memorial 500 can also include a testimonial section 515, where users can post testimonial messages regarding the deceased user 505. In addition to testimonials, users can also post homage tokens for the deceased user 505. As shown, a user can post an homage token to an homage token section 520 located at the bottom of the memorial 500. An homage token can include an image of an item or action such as a candle, flower, prayer, etc., that a person would place or perform at a memorial to pay homage to the deceased individual.

In some embodiments, the memorial 500 can include a premium homage token section 525, where a user can post a premium homage token. For example, a user can pay a fee to post a premium homage token to the premium homage token section 525, where the posted homage token can be presented prominently rather than at the bottom of the memorial 500.

FIG. 5B illustrates the memorial 500 after homage tokens have been posted to the premium homage token section 525. As shown, three homage tokens 530, 535, and 540 have been posted to the premium homage token section 525. The premium homage tokens can be displayed prominently near the image of the deceased user 505, rather than at the bottom of the memorial.

Further, a premium homage token can include multimedia content (audio, video, image, etc.) that can be displayed or played back for other users viewing the memorial 500. For example, the premium homage token 530 includes an icon representing that the homage token 530 includes an audio recording. A user viewing the memorial 500 can select the homage token 530 to play back the recorded audio.

An homage token can also include data identifying the user that posted the homage token as well as other data such as the date and time that the homage token was posted. For example, the homage token 535 includes data indicating that the homage token 535 was posted at 9:45 by user “Mauro M” and the homage token 540 includes data indicating that the homage token 540 was posted at 10:03 by an anonymous user.

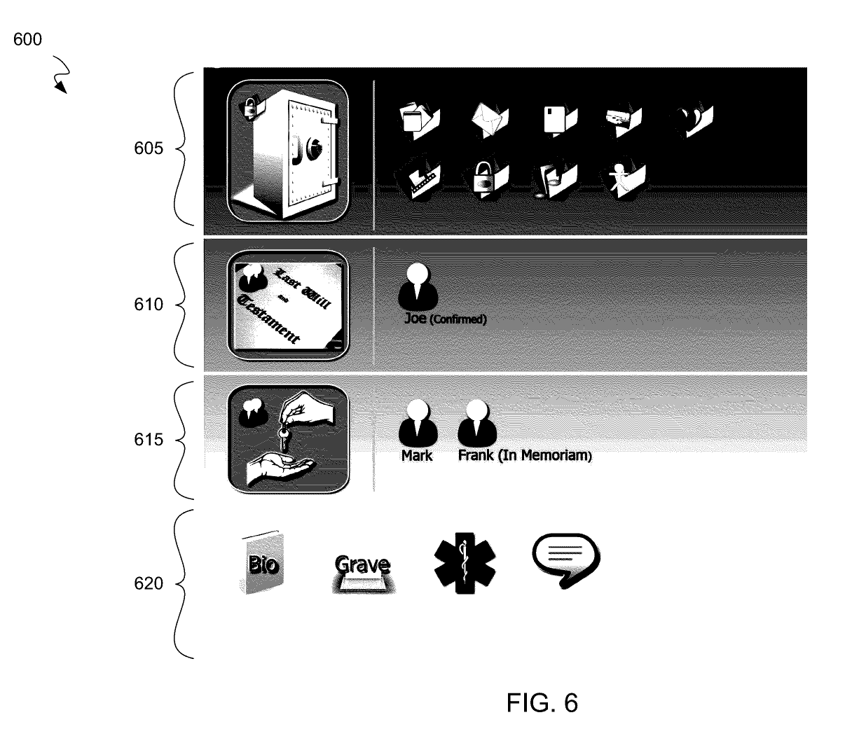

FIG. 6 illustrates an exemplary embodiment of an asset management interface. As shown, a user can be presented with an asset management interface 600 that can enable a user to manage their digital assets, manage inheriting users, and prepare their memorial. As shown, the asset management interface 600 includes a digital asset section 605 where a user can store digital assets. The digital asset section 605 can include multiple folders and/or directories that can be used by a user to manage their digital assets. A user can drag and drop digital assets into the folders included in the digital asset section 605 to store their digital assets.

The asset management interface 600 can also include an inheriting user section 610 that identifies the inheriting users designated for the primary user. For example, the inheriting user section 610 can include an icon that identifies each inheriting user designated by the primary user to inherit digital assets upon the passing away of the primary user. In some embodiments, the icon identifying the inheriting user can be selectable to access and configure user settings associated with designating a user as an inheriting user.

The asset management interface 600 can also include an inheriting user designation section 615 that identifies the user account for which the primary user has been designated as an inheriting users assigned to the primary user's account. For example, the inheriting user designation section 615 can include icons identifying the user accounts that have designated the primary user as an inheriting user. Further, the icons identifying each user account can be selectable to access and configure setting regarding the primary user's designation as an inheriting user. For example, the primary user can opt in or out of being an inheriting user.

The asset management interface can also include a memorial section 620 that enables a primary user to manage their memorial. For example, the memorial section 620 can enable a user to select to edit their bio, images, etc.

FIG. 7A, and FIG. 7B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A system for programmatic inheritance of digital assets, comprising:
a computer processor;
an account management module configured to create, for a primary user, a primary user account referencing a first digital asset; and
an inheritance module executing on a computer processor and configured to cause the computer processor to:
configure permissions designating a first inheriting user as an inheritor of the first digital asset, wherein the primary user is authorized to access the first digital asset and the first inheriting user is not authorized to access the first digital asset;
define at least one programmatic trigger condition for determining that a digital asset transfer should occur;
receive a request to execute the programmatic trigger condition, wherein the request comprises credentials corresponding to a trusted source;
determine that the programmatic trigger condition is satisfied based on the credentials; and
in response to determining that the programmatic trigger condition is satisfied, authorize the first inheriting user to access the first digital asset.

2. The system of claim 1, wherein the inheritance module is further configured to cause the computer processor to:
send a message requesting a proof of life verification from the primary user; and
determine that a timer has expired without receiving the proof of life verification, wherein determining that the programmatic trigger condition is satisfied is further based on determining that the timer has expired.

3. The system of claim 1, wherein authorizing the first inheriting user to access the first digital asset comprises:
assigning the first digital asset to a first inheriting user account the first inheriting user is authorized to access.

4. The system of claim 1, wherein determining that the programmatic trigger condition is satisfied comprises:
receiving, from a trusted user designated by the primary user, a notification that the primary user is deceased.

5. The system of claim 1, wherein the inheritance module is further configured to cause the computer processor to:
provide a prompt to the primary user for contact information associated with a person that the primary user wishes to designate to inherit the first digital asset; and
receive first contact information identifying the first inheriting user in response to the prompt.

6. The system of claim 5, wherein the inheritance module is further configured to cause the computer processor to:
send a message to the first inheriting user using the first contact information, wherein the message notifies that the first inheriting user has been designated as an inheriting user for the primary user account.

7. The system of claim 5, wherein the inheritance module is further configured to cause the computer processor to:
receive, from the primary user, input designating the first digital asset assigned to the primary user account to be inherited by the first inheriting user.

8. The system of claim 5, wherein the inheritance module is further configured to cause the computer processor to:
receive, from the primary user, second contact information identifying a second inheriting user;
receive, from the primary user, input designating a second digital asset assigned to the primary user account to be inherited by the second inheriting user; and
after determining that the programmatic trigger condition is satisfied, authorize the second inheriting user to access the second digital asset.

9. A method for programmatic inheritance of digital assets, comprising:
creating, for a primary user, a primary user account referencing a first digital asset;
configuring permissions designating a first inheriting user as an inheritor of the first digital asset, wherein the primary user is authorized to access the first digital asset and the first inheriting user is not authorized to access the first digital asset;
defining at least one programmatic trigger condition for determining that a digital asset transfer should occur;
receiving a request to execute the programmatic trigger condition, wherein the request comprises credentials corresponding to a trusted source;
determining that the programmatic trigger condition is satisfied based on the credentials; and
in response to determining that the programmatic trigger condition is satisfied, authorizing the first inheriting user to access the first digital asset.

10. The method of claim 9, further comprising:
sending a message requesting a proof of life verification from the primary user; and
determining that a timer has expired without receiving the proof of life verification, wherein determining that the programmatic trigger condition is satisfied is further based on determining that the timer has expired.

11. The method of claim 9, wherein authorizing the first inheriting user to access the first digital asset comprises:
assigning the first digital asset to a first inheriting user account the first inheriting user is authorized to access.

12. The method of claim 9, wherein determining that the programmatic trigger condition is satisfied comprises:
receiving, from a trusted user designated by the primary user, a notification that the primary user is deceased.

13. The method of claim 9, further comprising:
providing a prompt to the primary user for contact information associated with a person that the primary user wishes to designate to inherit the first digital asset; and
receiving first contact information identifying the first inheriting user in response to the prompt.

14. The method of claim 13, further comprising:
sending a message to the first inheriting user using the first contact information, wherein the message notifies that the first inheriting user has been designated as an inheriting user for the primary user account.

15. The method of claim 13, further comprising:
receiving, from the primary user, input designating the first digital asset assigned to the primary user account to be inherited by the first inheriting user.

16. The method of claim 13, further comprising:
receiving, from the primary user, second contact information identifying a second inheriting user;
receiving, from the primary user, input designating a second digital asset assigned to the primary user account to be inherited by the second inheriting user; and
after determining that the programmatic trigger condition is satisfied, authorizing the second inheriting user to access the second digital asset.

17. A non-transitory computer-readable medium comprising instructions for programmatic inheritance of digital assets, the instructions when executed by a computing device causing the computing device to:
create, for a primary user, a primary user account referencing a first digital asset;
configure permissions designating a first inheriting user as an inheritor of the first digital asset, wherein the primary user is authorized to access the first digital asset and the first inheriting user is not authorized to access the first digital asset;
define at least one programmatic trigger condition for determining that a digital asset transfer should occur;
receive a request to execute the programmatic trigger condition, wherein the request comprises credentials corresponding to a trusted source;
determine that the programmatic trigger condition is satisfied based on the credentials; and
in response to determining that the programmatic trigger condition is satisfied, authorize the first inheriting user to access the first digital asset.

18. The non-transitory computer-readable medium of claim 17, the instructions further causing the computing device to:
send a message requesting a proof of life verification from the primary user; and
determine that a timer has expired without receiving the proof of life verification, wherein determining that the programmatic trigger condition is satisfied is further based on determining that the timer has expired.

19. The non-transitory computer-readable medium of claim 17, wherein determining that the programmatic trigger condition is satisfied comprises:
receiving, from a trusted user designated by the primary user, a notification that the primary user is deceased.

20. The non-transitory computer-readable medium of claim 17, the instructions further causing the computing device to:
provide a prompt to the primary user for contact information associated with a person that the primary user wishes to designate to inherit the first digital asset; and
receive first contact information identifying the first inheriting user in response to the prompt.
receive, from the primary user, second contact information identifying a second inheriting user;
receive, from the primary user, input designating a second digital asset assigned to the primary user account to be inherited by the second inheriting user; and
after determining that the programmatic trigger condition is satisfied, authorize the second inheriting user to access the second digital asset.
